(19) United States
(12) Patent Application Publication
(10) Pub. No.: US 2024/0427358 A1
(43) Pub. Date: Dec. 26, 2024

(54) MULTI-ORIFICE BACK PRESSURE REGULATOR WITH SEAL ENHANCED POSITIVE SHUT-OFF

(71) Applicant: Equilibar, LLC, Fletcher, NC (US)

(72) Inventors: Tony Boyd Tang, Mills River, NC (US); Zachary Allan Cobb, Candler, NC (US); Jeffrey Dean Jennings, Hendersonville, NC (US); Eugene Charles Jansen, Stafford, VA (US); Keith Alan Roberts, Penrose, NC (US)

(21) Appl. No.: 18/703,058

(22) PCT Filed: Nov. 18, 2022
(86) PCT No.: PCT/US22/80133

§ 371 Date: Apr. 19, 2024

Related U.S. Application Data
(60) Provisional application No. 63/280,935, filed on Nov. 18, 2021.

(51) Int. Cl. G05D 16/00; G05D 16/06

(52) U.S. Cl. CPC G05D 16/024; G05D 16/0641

(57) ABSTRACT

A pressure regulating valve includes: a body, including: a process surface; at least one inlet orifice in the process surface; In outlet orifices disposed in the process surface separate from the at least one inlet orifice; a resilient shut-off seal positioned in the process surface, defining a closed perimeter surrounding the at least one inlet orifice and separating the at least one inlet orifice from the plurality of outlet orifices; an inlet port communicating with the at least one inlet orifice; and an outlet port communicating with the plurality of outlet orifices; a reference housing; and a diaphragm constrained between the body and the reference housing, and arranged such that, when a reference pressure is higher than a process pressure the diaphragm is engaged with the outlet orifices, and when the process pressure is higher than the reference pressure, the diaphragm is disengaged from at least one outlet orifice.

### BACKGROUND OF THE INVENTION

The present invention relates to pressure regulation, and more particularly to a diaphragm-type valve which balances a process pressure against a reference pressure signal.

Direct sealing diaphragm back pressure regulators have been utilized to provide precise pressure control in a wide variety of applications. These devices utilize a pilot or reference pressure on one side of the diaphragm and control a similar pressure on the process inlet port of the BPR approximately 1:1. Equilibar has specialized in these devices with multiple outlet orifices to enhance precision and breadth of flow control range.

One of the primary disadvantages of these direct sealing diaphragm valves (BPRs) is that their shut-off is typically not positive, such as with a traditional valve. Depending on the pressure range and the diaphragm thickness, it is possible to obtain shut-off down to the range of 1/1000 to 1/10,000 of maximum flow coefficient Cv in the range of 100 psig. At higher pressures, for example, up to 1000 psig or 3000 psig, it is possible to get shut-off to much lower flow rates (say 1/100,000 of max Cv) with diaphragms in the Shore D hardness range. For industrial BPRs in the port range of ½ in. or 1 in. pipe, for example, the effective shut-off may be in the range of several liters/minute of gas flow or several ml/min of liquid flow.

There is a need for a BPR with the multitude of advantages of the multiple orifice direct sealing diaphragm valve, but with practical effective shut-off, for example drip-tight, or nearly or absolutely bubble-tight, and/or with shut-off ratios in the range better than 1/100,000 of maximum Cv or down to 1/1,000,000 of maximum Cv, and to achieve this with harder diaphragms such as for metallic diaphragms.

### BRIEF SUMMARY OF THE INVENTION

This need is addressed by a valve using a direct-sealing diaphragm in conjunction with a shut-off seal.

According to one aspect of the technology described herein, a pressure regulating valve includes: a body, including: a process surface; at least one inlet orifice disposed in the process surface and adapted to be disposed in fluid communication with a fluid at a process pressure; a plurality of outlet orifices disposed in the process surface separate from the at least one inlet orifice; a resilient shut-off seal positioned in the process surface, defining a closed perimeter surrounding the at least one inlet orifice and separating the at least one inlet orifice from the plurality of outlet orifices; an inlet port disposed in fluid communication with the at least one inlet orifice; and an outlet port disposed in fluid communication with the plurality of outlet orifices; a reference housing adapted to be disposed in fluid communication with a fluid at a predetermined reference pressure; and a diaphragm having opposed reference and process sides, the diaphragm constrained between the body and the reference housing such that the process side faces the process surface, and arranged such that, when the reference pressure is higher than the process pressure the diaphragm is engaged with the outlet orifices, and when the process pressure is higher than the reference pressure, the diaphragm is not engaged with at least one of the outlet orifices.

### BRIEF DESCRIPTION OF THE DRAWINGS

The invention may be best understood by reference to the following description taken in conjunction with the accompanying drawing figures in which:

FIG. 1 is a top perspective view showing an exemplary embodiment of a valve;

FIG. 2 is a bottom perspective view of the valve shown in FIG. 1;

FIG. 3 is a top plan view of the valve shown in FIG. 1;

FIG. 4 is a section perspective view of the valve shown in FIG. 1;

FIG. 5 is a cross-sectional view taken along lines 5-5 of FIG. 3;

FIG. 6 is a perspective view of a portion of a body of the valve of FIG. 1;

FIG. 7 is a top plan view of the body shown in FIG. 6;

FIG. 8 is a schematic diagram of a piping system using a pressure regulating valve;

FIG. 9 is a perspective view of a portion of a modification of the body of the valve of FIG. 1; and

FIG. 10 is a cross-sectional view of a portion of a body of the valve showing an alternative seal retention means.

### DETAILED DESCRIPTION OF THE INVENTION

Described herein is a direct sealing diaphragm pressure regulating valve which incorporates an additional shut-off seal that is able to enhance shut-off, but configured to avoid interfering with the precision of the multi-orifice design during a normal operating regime. The geometry supports both enhanced shut-off during no-flow regimes, but also provides for the highly precise pressure versus flow curves that support precision applications using the multiple orifice design.

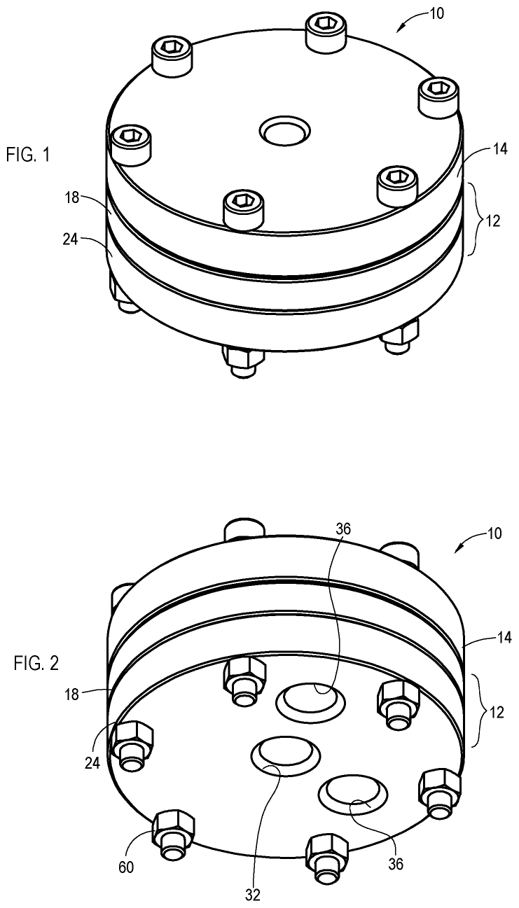

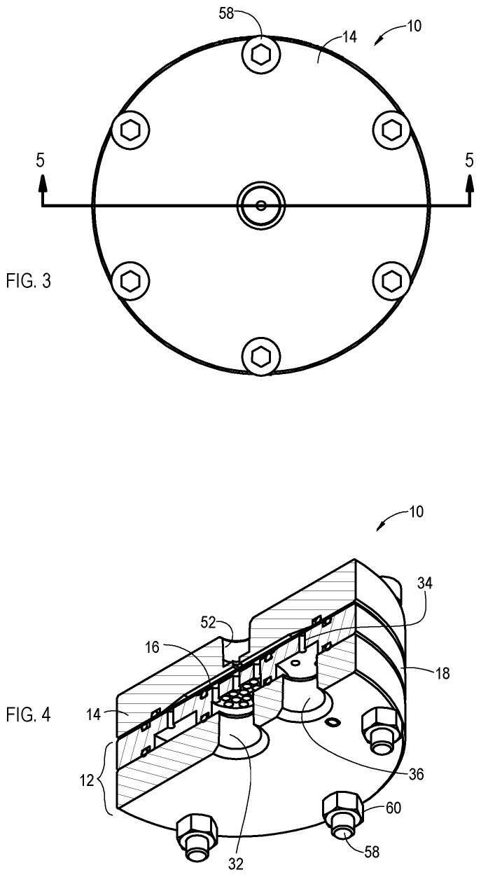

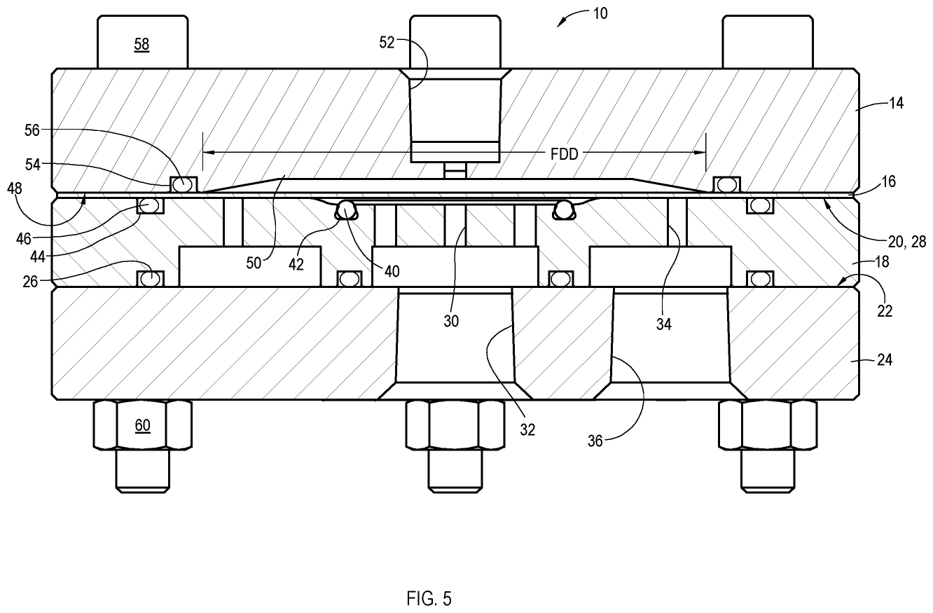

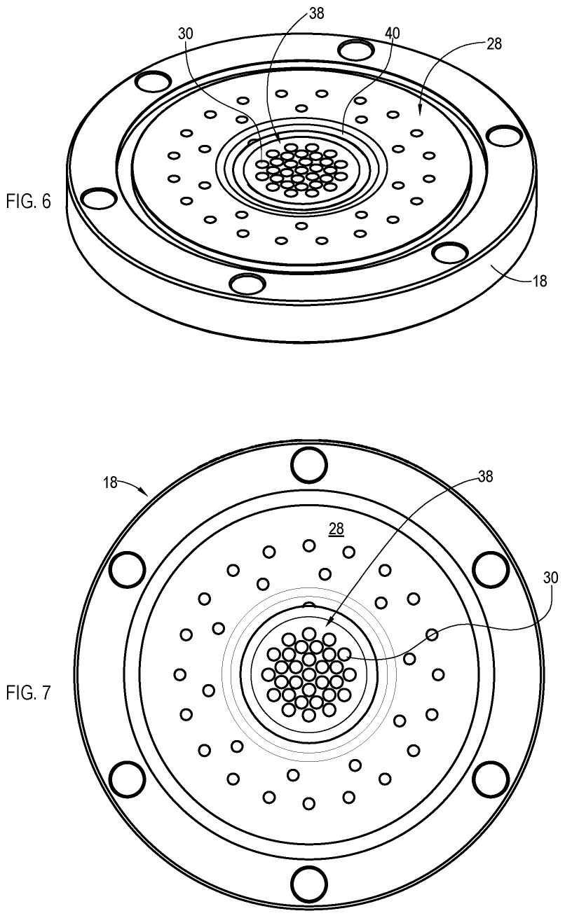

Referring to the drawings wherein identical reference numerals denote the same elements throughout the various views, FIGS. 1-5 illustrate an exemplary pressure regulating valve 10 constructed according to one aspect of the present invention.

The term “pressure regulating valve” is used here generically to refer to a device which is responsive to differential pressures applied thereto and which is capable of functioning as either a back pressure regulator or as a relief valve, depending on how it is arranged within a fluid system.

For purposes of explanation, it is noted that “back pressure regulator” and “relief valve” are two similar terms which describe the same functional device, though with different operational emphases. The basic components of the pressure regulating valve 10 are a body 12, a reference housing 14, and a diaphragm 16.

The body 12 may have various different configurations as dictated by cost, manufacturability, or other considerations. In the illustrated example, the body 12 is built from a disk-like center section 18 with opposed top and bottom surfaces 20, 22. The bottom surface 22 abuts a bottom cap 24. Resilient seals 26 such as O-rings seal any gaps between the center section 18 and the bottom cap 24.

The body has a process surface 28. The process surface 28 is generally planar in the illustrated example, but different geometries may be used, for example, the process surface 28 may include various recesses or protrusions.

At least one inlet orifice 30 communicates with the process surface 28. The function of the inlet orifice (or orifices) 30 is to bring the process fluid into the pressure regulating valve 10. The inlet orifice (or orifices) 30 communicate with an inlet port 32 formed in the body 12.

A plurality of outlet orifices 34 communicate with the process surface 28. The function of the outlet orifices 34 is to vent process fluid from the pressure regulating valve 10. The outlet orifices 34 communicate with an outlet port 36 formed in the body 12.

The inlet orifices 30 (if more than one is present) are grouped together forming a cluster 38. A shut-off seal 40 defines an outer perimeter of the cluster 38 of inlet orifices 30. The shut-off seal 40 functions to separate the inlet orifice (or orifices) 30 from the outlet orifices 34. In the illustrated example, the shut-off seal 40 comprises a resilient seal member (such as an O-ring) disposed in a shut-off seal groove 42 formed in the process surface 28. In this example, the shut-off seal groove 42 is circular in plan view, but other closed shapes may be used. It is noted that O-rings are typically described using two dimensions: the inside diameter, which is the diameter of the open area in the center of the circular plan view, and the cross-sectional diameter, which is the diameter of the elastomer or other material forming the circular shape. For example, the thickness or height of an O-ring when placed on a flat surface would generally be equal to the cross-sectional diameter.

In the illustrated example, the cluster of inlet orifices 30 is located in the center of the body 12, with the outlet orifices 34 located around the cluster 38, with significant spacing between the outlet orifices 34. Alternatively, the cluster 38 of inlet orifices 30 could be located to one side of the process surface 28 to accommodate opposed porting configurations.

The body 12 may be manufactured using various methods such as machining from a block of precursor material, additive manufacturing processes (e.g., “3-D printing”), or molding from a polymer suitable for the application requirements.

The process surface 28 has a lower seal groove 44 formed therein. A resilient lower seal 46, for example an O-ring, is disposed in the lower seal groove 44.

The flexible diaphragm or membrane 16 is disposed adjacent the process surface 28. The diaphragm 16 has opposed sides, referred to as reference and process sides, with the process side facing the process surface 28.

Nonlimiting examples of suitable constructions for the diaphragm 16 include the following:

In one example, the diaphragm 16 may be a polymer film of hardness in the Shore D range from D40 to D90, such as PTFE, PEEK, polyimide, or polyethylene. Preferred thickness ranges from 0.002 in. to 0.060 in., more preferably between 0.003 in. and 0.020 in.

In another example the diaphragm 16 may be glass reinforced PTFE.

In another example the diaphragm 16 may be a flexible metal foil such as SS316 or Hastelloy C276, in the thickness range of 0.002 in. to 0.040 in.

In another example, the diaphragm 16 could be an elastomeric membrane such as fiber reinforced rubber material in the thickness range of 0.008 in. to 0.060 in., with a preferred range of 0.010 in. to 0.030 in.

The reference housing 14 is a generally rigid member having a reference surface 48 which is shaped to define an internal reference cavity 50. A integral reference port 52 is connected in fluid communication with the reference cavity 50. The reference housing reference surface 48 has an upper seal groove 54 formed therein. A resilient upper seal 56, for example an O-ring, is disposed in the upper seal groove 54.

The reference housing 14 may be manufactured using various methods such as machining from a block of precursor material, additive manufacturing processes (e.g., “3-D printing”), or molding from a polymer suitable for the application requirements.

Means are provided for joining the reference housing 14 to the body 12 and to hold pressure forces. In the illustrated example, an array of clamp bolts 58 pass through the reference housing 14, the center section 18, and the bottom cap 24, and are secured by clamp nuts 60.

The function of the pressure regulating valve 10 is as follows. A reference pressure is applied to the reference side of the diaphragm 16. The diaphragm 16 can open or close fluid communication between the inlet orifices 30 and the outlet orifices 34 depending on the pressure differentials between the reference pressure and the process inlet pressure. When the reference pressure increases above the inlet pressure, the diaphragm 16 moves towards a closing bias.

When the inlet pressure increases significantly above the reference pressure (plus or minus some small bias), the diaphragm 16 moves toward the opening state to allow flow. When the inlet pressure falls significantly below the reference pressure (plus or minus some small bias), the diaphragm 16 moves toward the closing state to restrict or shut off flow.

The shut-off seal 40 comes into play at low flow rates. More specifically, the location of a primary pressure drop across the pressure regulating valve 10 will move to the shut-off seal 40 when flow rates drop down near the minimum, but the primary pressure drop will relocate to be at the multiple outlet orifices 34 when the flow rate rises up into the range that the outlet orifices 34 are capable of (discussed above). Trying to operate the pressure regulating valve 10 with only the shut-off seal 40 without the multiple outlet orifices 34 capable of effecting a seal would cause severe pulsations and binary on/off behavior.

Small differences in the diaphragm selection and the exact geometry of the orifices and the shut-off seal 40 can affect the bias, though biases are typically below 5% of the overall differential pressure across the device.

For example, trials have demonstrated that raising the top edge of the shut-off seal 40 slightly above the plane of the outlet orifices 34 tends to bias the inlet pressure to be slightly higher than the reference pressure (closing bias), whereas lowering the shut-off seal 40 slightly below the plane of the outlet orifices 34 tends to lower the inlet pressure less than the reference pressure (opening bias). (As used herein, the term “top edge” refers to the furthest protrusion of the shut off seal 40). Having too much closing bias can lead to instability during the normal operating of the valve, so the critical factor for a given geometry, diaphragm property, and pressure range is to identify the right shut-off seal placement (bias) to avoid instability in the desired flow range.

The function of the pressure regulating valve 10 may be enhanced by the selection of certain geometric features. Unless otherwise noted, any of the features may be used in conjunction with any of the other features. Some of these features are summarized below.

### Diaphragm Movement Gap

The diaphragm movement gap is a value that defines the maximum distance normal to the plane of sealing constraint that the diaphragm 16 is allowed to move as the pressure imbalance causes it to move from the reference surface 48 to the process surface 28. In one example, the diaphragm movement gap may between 0.8% and 3.5% of the free diaphragm diameter “FDD”, where FDD is defined as the diameter of the diaphragm 16 that is free to move up and down, inside the inner most seal constraint. (The diaphragm 16 has a corresponding free surface area.) In another example, the movement gap may be between 1.2% and 2.5% of the free diaphragm diameter.

### Shut-Off Seal Location Relative to Outlet Orifices

In one example, the top edge of the shut-off seal 40 may be above or below the height of the nearest outlet orifices 34 by a tolerance of 0.2% or less, preferably within 0.1%, of the free diaphragm diameter FDD.

In one example, the top edge of the shut-off seal 40 is above or below the height of the nearest outlet orifices 34 by a tolerance of 5% or less, preferably within 2%, of the shut-off seal cross-sectional diameter.

### Shut-Off Seal Location Relative to Inlet Orifice Surface

Optionally, the top edge of the shut-off seal 40 protrudes above a plane which is axially coincident with the highest surface inside the perimeter of the shut-off seal by at least 0.005 in., but not greater than 0.060 in., with a preferred height of between 0.007 in. and 0.020 in.

Optionally, the top edge of the shut-off seal 40 protrudes above a plane which is axially coincident with the highest surface inside the shut-off seal 40 by between 6 and 30% of the shut-off seal diameter “D”, with a preferred height of between 10% and 22%.

### Geometry of Outlet Orifices

Optionally, the outlet orifices 34 may be located around the portion of the process surface 28 such that the sum total open area of the outlet orifices 34 occupies between 0.8% and 5% of the total area of the free diaphragm area.

Optionally, a majority of the outlet orifices 34 may be located at least 4 (of their own) orifice diameters from each other or any other sealing component or constraint. Preferably, a majority of the outlet orifices 34 are at least 5 orifice diameters from each other or any other sealing component or constraint.

Optionally, there are multiple sizes of outlet orifices 34.

Optionally, the sum of the open area of the outlet orifices 34 is non-uniformly distributed in a radial manner as to provide non-uniform diaphragm liftoff and further reduce binary behavior. In a specific example of this embodiment, when dividing the circular free diaphragm area into radial slices of 2, 3, or 4 equal segments (pie slices), the sum total cross sectional area of the outlet orifices 34 in each segment would vary by more than 20% from the maximum to minimum per slice.

### Shut-Off Seal Groove Shaping

Optionally, the shut-off seal groove 42 has a non-planar bottom surface such that the installed shut-off seal 40 exhibits “waviness”, i.e., a shape including containing two or more peaks and two or more troughs. The height of such waviness (peak to trough) may be from 1% to 10% of cross-section diameter of the shut-off seal 40 (or its thickness if not a circular cross-section). The purpose of this waviness is to stabilize the diaphragm 16 during low flow operation by allowing some contact between diaphragm 16 and the shut-off seal 40, while still allowing for flow to pass through. The waviness is small enough to allow for shut-off seal compression to further compress and fully block the flow when the overpressure (pilot-inlet) pressure reaches an intended threshold.

### Shut-Off Seal Configuration

A preferred design for the shut-off seal 40 is an elastomeric O-ring such as FKM, FFKM, NBR, EPDM, silicone or any other commercially available O-ring. Most preferred hardness is in the range of Shore A50 to Shore A 90. The example design shown uses an FKM O-ring with thickness of 0.07 in.

Additional embodiments may utilize O-ring seals using polymers in Shore D range, such as PTFE.

In a key embodiment where the shut-off seal 40 is an O-ring, the shut-off seal groove 42 has a width approximately equal to or preferably slightly less than the actual O-ring cross-section diameter so that the O-ring is easily retained in the shut-off seal groove 42 by compressive contact with the side wall of the groove.

Optionally, the shut-off seal groove 42 would be filled by the shut-off seal 40 between 95% and 100% if the diaphragm 16 were to compress the seal fully into the groove without protrusion (as would be in a standard face seal calculation).

In a preferred embodiment, the shut-off seal groove 42 contains a dove-tail or other similar geometry to more positively retain the shut-off seal 40 in the shut-off seal groove 42.

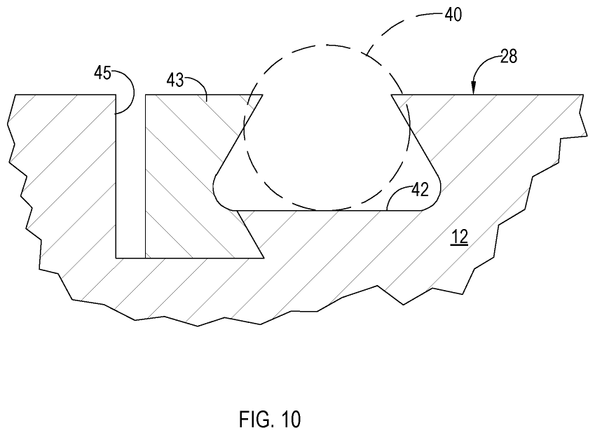

In another preferred embodiment, the shut-off seal groove 42 contains both elements of a dove-tail groove, and an additional retention ring that positively prevents seal migration out of the shut-off seal groove 42. Such a retention ring could be a type of (or modification of) an internal snap ring. A key feature of the retention ring would be to leave at least the top 15% of the O-ring cross-sectional diameter (in an uncompressed state) free of obstruction by either the shut-off seal groove 42 or any retention ring. FIG. 10 shows one possible example configuration. In this example, a portion of the shut-off seal groove 42 is integrally formed with the valve body 12. The remaining portion of the shut-off seal groove 42 is defined by a resilient snap ring 43 which fits into a snap ring groove 45 formed adjacent to the shut-off seal groove 42. The cross-sectional size of the uncompressed shut-off seal 40 is shown in dashed lines in FIG. 10. It can be seen that this configuration permits strong retention of the shut-off seal 40 while simplifying assembly and disassembly. It will be understood that the shut off seal 40 can be placed in the shut off seal groove 42 and then secured in place with the snap ring 43. The procedure can be reversed to remove the shut-off seal 40.

In an additional embodiment, the shut-off seal 40 is an “X-ring” or four-lobe cross section ring such for the purpose of providing a tighter radius of contact between the diaphragm 16 and the shut-off seal 40. Such X-rings are commercially available.

Optionally, the shut-off seal 40 has a square cross-sectional shape (i.e., is a “square ring”) to provide additional sealing pressure through a more acute contact radius.

Optionally, the shut-off seal 40 is bonded to the body 12, presenting an exposed geometry that is effectively similar to any of the three above-mentioned seal cross sections (circular, square, or 4-lobed).

Optionally, the wetted surface supporting the diaphragm 16 is not planar, but contains sloping or curved surfaces. In such an embodiment, each of the embodiment constraints mentioning O-ring protrusion above/below surface would be referenced to the axial height of the nearest outlet orifice.

Optionally, the top edge of the shut-off seal 40 protrudes above the local surface by an amount between 0.1% and 0.4% of the free diameter of the diaphragm 16, with a preferential height between 0.15% and 0.3% of the free diaphragm diameter.

In an alternative embodiment, the diaphragm 16 is an elastomer or fabric reinforced elastomeric sheeting with Shore A hardness between Shore A50 and Shore A95. For this elastomer embodiment with the softer diaphragm material, the body geometry may incorporate the above seal geometries as integrated, having a hardness of a Shore D polymer such as PVC, PEEK, PTFE or may be made of metal such as stainless steel or other metals. In this embodiment the body geometry would present the radial, square, or 4-lobed interface with the indicated raised geometry as if the indicated seals were inserted, according to the specified height ratios discussed above.

### Raised Areas Adjacent to Shut-Off Seal

Testing has shown that under some circumstances, the diaphragm 16 may be prone to catching on the shut-off seal 40, requiring very high overpressure to raise the diaphragm 16 off the shut-off seal 40. This may result in undesirable on/off flow oscillations in a low-flow transition zone.

This possibility may be avoided by incorporating one or more raised areas or protrusions in the process surface 28, that are raised above the outlet orifice plane on the outside of the shut-off seal 40, and located adjacent to the shut-off seal 40.

The raised areas will prevent the diaphragm 16 from being locked downward. In operation, whenever the inlet pressure is greater than the reference pressure, the intersection of the raised area and the diaphragm 16 provides a path for gas to go over the shut-off seal 40 and to work in a normal way with the outlet orifices 34. As the inlet pressure falls below the reference pressure, the shut-off seal 40 is present to create a seal as described above. As flow increases to higher rates, the diaphragm 16 is able to raise up completely above the shut-off seal 40 and operate normally as well.

In the example shown in FIG. 9, the process surface 28 includes a pair of flat-topped protrusions 62, at diametrically opposed sides of the shut-off seal 40. Fewer or more protrusions 62 may be used to suit a particular application. The protrusions 62 in FIG. 9 are generally rectangular but other shapes may be used.

The protrusions 62 should extend relatively close to the shut-off seal 40. In one example, the protrusions 62 may be located such that a gap between their closest portions and the outside of the shut-off seal 40 is within 1% of the free diaphragm diameter.

In one example, the protrusions 62 are raised above the plane of at least one outlet orifice 34 by 0.2% to 1% of the free diaphragm diameter, with a preferred range being between 0.3% and 0.8%.

In another example, the protrusion 62 has a height (i.e. position of its top surface) compared with the top edge of the shut-off seal 40 of between −0.5% (below the seal top edge) and +0.5% (above the seal top edge) of free diaphragm diameter.

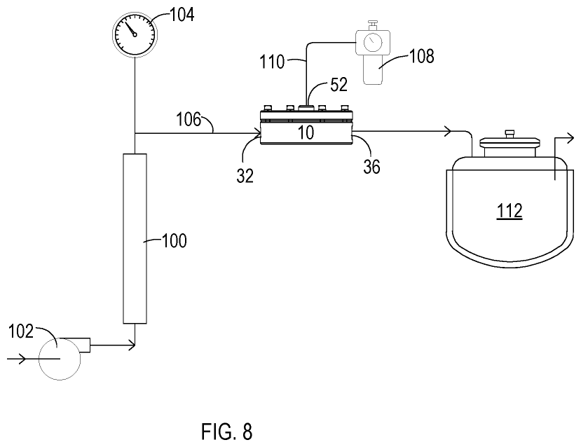

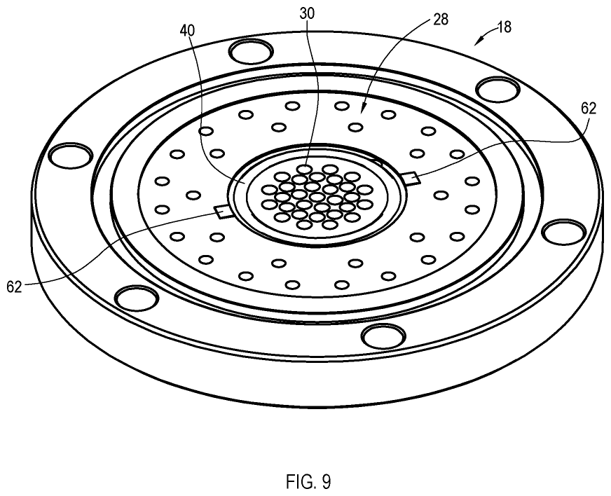

FIG. 8 is a schematic representation of a representative industrial process incorporating the pressure regulating valve 10 described above. This is but one of many types of process system which utilize a control valve and/or back pressure regulator. The system includes a process vessel 100 coupled to a compressor 102 and a pressure gauge 104. The process vessel 100 is connected to the inlet port 32 of the pressure regulating valve 10 by an inlet line 106. The reference port 52 of the pressure regulating valve 10 is connected to a pressure reference source 108 by a reference line 110. During normal balanced or modulating mode, the control diaphragm 16 is drawn into a sealing relationship with the outlet orifices 34 due to the pressure differential between the vessel pressure and reference pressure. When the vessel pressure exceeds the reference pressure the area of the control diaphragm 16 between the outlet orifices 34 is persuaded away from the outlet orifices 34 thereby allowing venting through the outlet port 36. In the illustrated example the outlet port 36 is coupled to a collection vessel 112. Optionally, the fluid may be discharged to atmosphere.

The valve described above has numerous advantages over prior art valves. In particular, it provides the precision of a multi-orifice direct sealing diaphragm valve while also providing a tight shut-off condition at low flow rates.

The foregoing has described a pressure regulating valve. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends any novel one, or any novel combination, of the features disclosed in this specification (including any accompanying claims, abstract and drawings), or to any novel one, or any novel combination, of the steps of any method or process so disclosed.

1. A pressure regulating valve, comprising:
a body, including:
a process surface;
at least one inlet orifice disposed in the process surface and adapted to be disposed in fluid communication with a fluid at a process pressure;
a plurality of outlet orifices disposed in the process surface separate from the at least one inlet orifice;
a resilient shut-off seal positioned in the process surface, defining a closed perimeter surrounding the at least one inlet orifice and separating the at least one inlet orifice from the plurality of outlet orifices;
an inlet port disposed in fluid communication with the at least one inlet orifice; and
an outlet port disposed in fluid communication with the plurality of outlet orifices;
a reference housing adapted to be disposed in fluid communication with a fluid at a predetermined reference pressure; and
a diaphragm having opposed reference and process sides, the diaphragm constrained between the body and the reference housing such that the process side faces the process surface, and arranged such that, when the reference pressure is higher than the process pressure the diaphragm is engaged with the outlet orifices, and when the process pressure is higher than the reference pressure, the diaphragm is not engaged with at least one of the outlet orifices.

2. The pressure regulating valve of claim 1 wherein a plurality of inlet orifices are disposed in the process surface and are arranged in a cluster.

3. The pressure regulating valve of claim 1, wherein a top edge of the resilient shut-off seal is positioned above or below the nearest one of the plurality of outlet orifices by a tolerance of 0.2% or less, of a free diameter of the diaphragm.

4. The pressure regulating valve of claim 1, wherein:
the shut-off seal is an O-ring; and
a top edge of the resilient shut-off seal is positioned above or below the nearest one of the plurality of outlet orifices by a tolerance of 5% or less, of a cross-sectional diameter of the shut-off seal.

5. The pressure regulating valve of claim 1, wherein a top edge of the resilient shut-off seal protrudes above a plane which is axially coincident with the highest portion of the process surface inside the closed perimeter of the shut-off seal by at least 0.005 inches, but not more than 0.060 inches.

6. The pressure regulating valve of claim 1, wherein a top edge of the resilient shut-off seal protrudes above a plane which is axially coincident with the highest portion of the process surface inside the closed perimeter shut-off seal by between 6% and 30% of the shut-off seal cross-section diameter.

7. The pressure regulating valve of claim 1, wherein, the outlet orifices are positioned around the process surface such that a sum total open area of the outlet orifices occupies between 0.8% and 5% of a total free area of the diaphragm.

8. The pressure regulating valve of claim 1, wherein a majority of the outlet orifices are located at least 4 of their own orifice diameters from each other.

9. The pressure regulating valve of claim 1, wherein there are multiple sizes of outlet orifices.

10. The pressure regulating valve of claim 1, wherein a sum of the open area of the outlet orifices is non-uniformly distributed in a radial manner.

11. The pressure regulating valve of claim 1, wherein:
the resilient shut-off seal is received in a shut-off seal groove formed in the process surface; and
the shut-off seal groove has a non-planar bottom surface including two or more peaks and two or more troughs.

12. The pressure regulating valve of claim 1, wherein the resilient shut-off seal is an elastomeric O-ring having a hardness in the range of Shore A50 to Shore A90.

13. The pressure regulating valve of claim 1, wherein the resilient shut-off seal is a polymeric O-ring having a hardness in the Shore D range.

14. The pressure regulating valve of claim 1, wherein:
the resilient shut-off seal is an O-ring;
the resilient shut-off seal is received in a shut-off seal groove formed in the process surface; and
the resilient shut-off seal is sized to file fill the shut-off seal groove between 95% and 100% under conditions of full compression without protrusion.

15. The pressure regulating valve of claim 1, wherein:
the resilient shut-off seal is an O-ring;
the resilient shut-off seal is received in a shut-off seal groove formed in the process surface; and
the resilient shut-off seal groove has a tapered shape to positively retain the shut-off seal.

16. The pressure regulating valve of claim 15, wherein the resilient shut-off seal groove includes an additional retention ring that is configured to leave a top 20% of the O-ring cross-sectional diameter free of obstruction.

17. The pressure regulating valve of claim 1, wherein the resilient shut-off seal is a four-lobe cross section ring.

18. The pressure regulating valve of claim 1, wherein, the resilient shut-off seal is bonded to the body.

19. The pressure regulating valve of claim 1, wherein a wetted surface supporting the diaphragm contains sloping or curved surfaces.

20. The pressure regulating valve of claim 1, wherein a top of the resilient shut-off seal protrudes above a local portion of the process surface by an amount between 0.1% and 0.4% of a free diameter of the diaphragm.

21. The pressure regulating valve of claim 1, wherein the diaphragm is an elastomer or fabric reinforced elastomeric sheeting with Shore A hardness between Shore A50 and Shore A95.

22. The pressure regulating valve of claim 1, wherein the process surface includes at least one protrusion that is raised above an outlet orifice plane on the outside Page 7 of the resilient shut-off seal, and is located adjacent to the resilient shut-off seal.

23. The pressure regulating valve of claim 22, wherein the at least one protrusion is located radially such that a gap between the closest portion of the at least one protrusion and the outside of the resilient shut-off seal is within 1% of a free diaphragm diameter.

24. The pressure regulating valve of claim 22, wherein the at least one protrusion is raised above a plane of at least one of the plurality of outlet orifices by 0.2% to 1% of a free diameter of the diaphragm.

25. The pressure regulating valve of claim 22, wherein the at least one protrusion has a top surface positioned between: 0.5% of a free diaphragm diameter below a top edge of the resilient shut-off seal, and 0.5% of a free diameter of the diaphragm above the top edge of the resilient shut-off seal.
